(19) United States
(12) Patent Application Publication
(10) Pub. No.: US 2022/0172699 A1
(43) Pub. Date: Jun. 2, 2022

(54) VISUAL REMOTE CONTROL ASSEMBLY FOR SHOW PERFORMANCE AND CORRESPONDING SYSTEM AND METHOD

(71) Applicant: Jeffrey Wayne CAYLOR, Clear Water Bay, New Territories (HK)

(72) Inventor: Jeffrey Wayne CAYLOR, Clear Water Bay, New Territories (HK)

(21) Appl. No.: 17/537,891

(22) Filed: Nov. 30, 2021

Related U.S. Application Data
(60) Provisional application No. 63/119,706, filed on Dec. 1, 2020.

(51) Int. Cl. G10H 1/00; G06F 16/638

(52) U.S. Cl. CPC G10H 1/0066; G06F 16/639; G10H 2220/106; G10H 2220/026; G10H 2220/096; G10H 1/0008

(57) ABSTRACT

A visual remote control assembly includes a housing hosting firmware suitable for allowing communication between the visual remote control assembly and a show computer; a display screen capable of receiving the communication from the show computer, the communication including data regarding a show performance, the display screen displaying the data regarding the show performance in an in-use operation of the visual remote control assembly, wherein the data regarding the show performance includes a song setlist including a current song, a next song, and a previous song; and a plurality of control mechanisms interacting with the firmware to thereby allow instructions to be sent to the show computer upon a user actuating the plurality of control mechanisms. A corresponding system and method are also provided.

### CROSS-REFERENCE TO RELATED APPLICATIONS

This application claims the benefit of U.S. Provisional Application No. 63/119,706, filed on Dec. 1, 2020, which is incorporated herein by reference.

### FIELD OF THE INVENTION

Embodiments of the present invention relate to a visual remote control assembly and corresponding system. Other embodiments of the present invention relate to a method that includes utilizing the visual remote control system when performing music along with a show computer.

### BACKGROUND OF THE INVENTION

Most musicians who perform onstage will utilize computers during the live performances. Typically, there is a person onstage or backstage, commonly referred to as a playback engineer, who controls a primary show computer serving as the nexus of the performance. The show computer plays music the band follows for each song, and the show computer also sends important data around the venue. For example, the show computer allows lighting, video, lyrics, pyrotechnics, and any other performance elements to sync perfectly with the overall music.

Consequently, accurately starting and stopping the songs on the show computer is highly critical to the live performance. Most commonly, the show computer is started or stopped using another hardware interface that acts as a remote control. However, these conventional hardware devices can suffer from drawbacks or disadvantages.

The present inventor, Jeff Caylor, has a strong history of experience performing music with a computer. The present inventor relied on this experience to identify the pain points of previously available systems. One such pain point is the need for quickly and confidently launching a song on the show computer while also interacting with the audience. It is generally undesirable for the musician to be constantly checking the show computer in a manner which detracts from the overall experience for the audience.

In the specific niche of selecting, launching, and stopping cues on the show or playback computer for music or theatre performance, there are only a handful of conventional dedicated controllers. None of these controllers are believed to allow a user to see any cues on the hardware device itself. Most technicians in this field are using a compact but repurposed device, such as a small Musical Instrument Digital Interface (MIDI) controller with drum pads.

There remains a need in the art for a system which allows a user (i.e. a musician and/or a show computer operator) to see names of songs on a discrete screen on an onstage remote control.

### SUMMARY OF THE INVENTION

An embodiment of the present invention provides a visual remote control assembly including a housing hosting firmware suitable for allowing communication between the visual remote control assembly and a show computer; a display screen capable of receiving the communication from the show computer, the communication including data regarding a show performance, the display screen displaying the data regarding the show performance in an in-use operation of the visual remote control assembly, wherein the data regarding the show performance includes a song setlist including a current song, a next song, and a previous song; and a plurality of control mechanisms interacting with the firmware to thereby allow instructions to be sent to the show computer upon a user actuating the plurality of control mechanisms.

According to one or more embodiments of the present invention, a visual remote control system includes a show computer having data regarding a show performance; a visual remote control assembly; and a wire or cable connecting the visual remote control assembly with the show computer; the visual remote control assembly including a housing hosting firmware suitable for allowing communication between the visual remote control assembly and the show computer across the wire or cable; a display screen receiving the communication from the show computer across the wire or cable, the communication including the data regarding the show performance, the display screen displaying the data regarding the show performance in an in-use operation of the visual remote control assembly, wherein the data regarding the show performance includes a song setlist including a current song, a next song, and a previous song; and a plurality of control mechanisms interacting with the firmware to thereby allow instructions to be sent to the show computer upon a user actuating the plurality of control mechanisms.

In yet other embodiments, a method of operating a visual remote control system includes steps of providing the visual remote control system including a visual remote control assembly, a show computer, and a wire or cable connecting the visual remote control assembly with the show computer; instructing the show computer to send initial data regarding a show performance to the visual remote control assembly; viewing the initial data regarding the show performance on a display screen of the visual remote control assembly; and instructing, via a control mechanism of the visual remote control assembly, the show computer to send additional data regarding a show performance to the visual remote control assembly, where the additional data is different from the initial data.

### BRIEF DESCRIPTION OF THE DRAWINGS

Advantages of the present invention will become better understood with regard to the following description, appended claims, and accompanying drawings wherein:

FIG. 1 is a schematic of a visual remote control assembly, according to one or more embodiments of the invention;

FIG. 2 is a schematic of the visual remote control assembly, showing a communication port, according to one or more embodiments of the invention;

FIG. 3 is a schematic of a visual remote control system including the visual remote control assembly, according to one or more embodiments of the invention; and

FIG. 4 is a schematic of a method that includes utilizing the visual remote control system, according to one or more embodiments of the invention.

### DETAILED DESCRIPTION OF THE INVENTION

One or more embodiments of the present invention relate to a visual remote control assembly. One or more embodiments of the present invention relate to a visual remote control system including the visual remote control assembly. One or more embodiments of the present invention relate to a method that includes utilizing the visual remote control system when performing music along with a show computer.

Advantageously, the visual remote control assembly of one or more embodiments of the present invention allows an onstage musician to see names of songs on a discrete screen of the visual remote control assembly, which can also act as an onstage remote control. Moreover, in view of the remote control function of the visual remote control assembly, the onstage musician can select, launch, and stop cues on a playback computer by utilizing the visual remote control assembly. That is, the visual remote control assembly is synchronized with the playback computer. And while conventional onstage controllers might allow for the controller to send note data or continuous controller (CC) data to the show computer, the visual remote control assembly of one or more embodiments of the present invention offers a visual display and moreover is capable of sending much more additional data (e.g. a selected cue, a previous cue, and a next cue), thereby giving more control to the onstage performer.

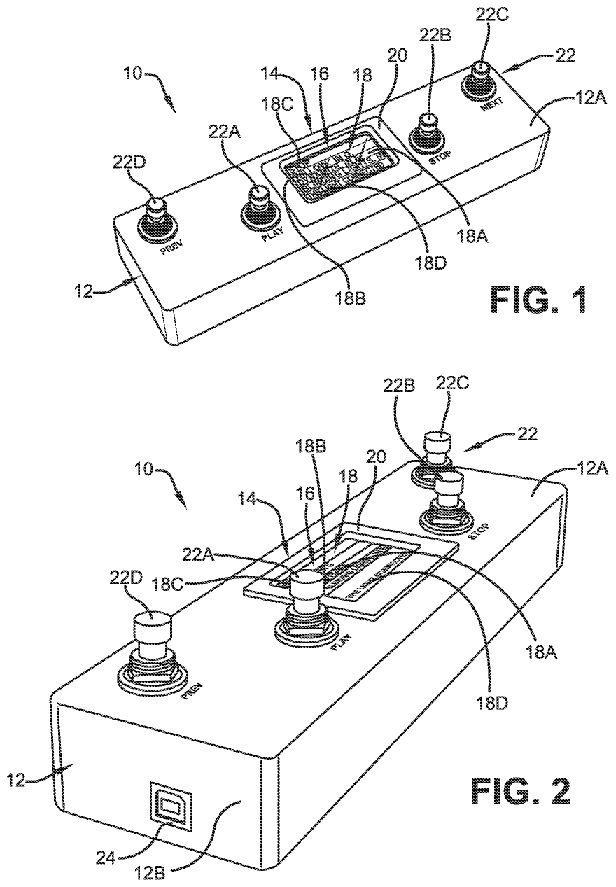

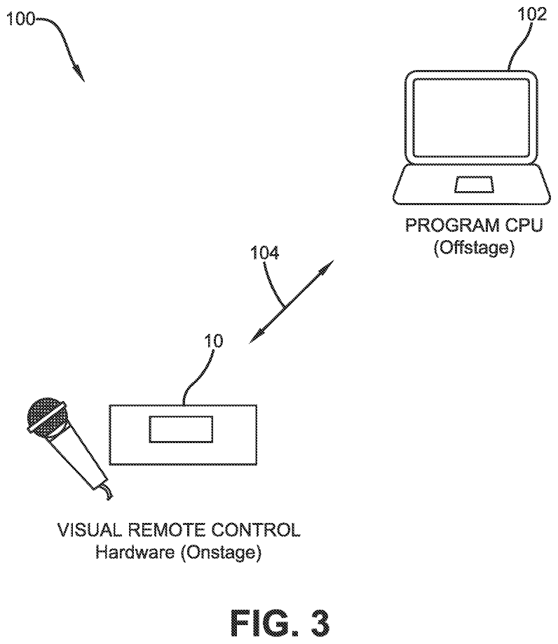

With reference to FIGS. 1-3, a visual remote control assembly according to one or more embodiments of the present invention is generally represented with the numeral 10. With specific reference to FIG. 3, a visual remote control system according to one or more embodiments of the present invention is generally represented with the numeral 100. Visual remote control system 100 includes visual remote control assembly 10 in communication with a show computer 102. With utilization of visual remote control system 100, visual remote control assembly 10 can interact with show computer 102 to thereby allow an onstage musician to control show computer 102 via visual remote control assembly 10.

As will be further described herein below, visual remote control assembly 10, which may also be referred to as a remote control hardware device 10 or a secondary hardware device 10, hosts firmware capable of allowing the interaction between visual remote control assembly 10 and show computer 102, particularly a central processing unit (CPU) thereof In one or more embodiments, both visual remote control assembly 10 and show computer 102, which may also be referred to as a program computer 102, a playback computer 102, a host computer 102, or a primary hardware device 102, are onstage.

In one or more embodiments, the communication between visual remote control assembly 10 and show computer 102 is serial communication. In one or more embodiments, the communication between visual remote control assembly 10 and show computer 102 is the standard Musical Instrument Digital Interface (MIDI) protocol of communication. The MIDI communications protocol uses a baud rate of 31250 bps (+1%). This rate of communication is more than sufficient to transmit the data described herein (e.g. a short packet of cue title information, MIDI clock data), as well as being sufficient for facilitating control data described herein (e.g. stop instruction, start instruction).

With further reference to FIGS. 1 and 2, visual remote control assembly 10 includes a housing 12 having a variety of sub-components. In one or more embodiments, the housing 12 is a compact form factor hardware device, which may also be referred to as a small form factor hardware device, but the housing can be any suitable size. The housing 12 may include a suitable battery or other suitable power input. In one or more embodiments, the housing 12 may be a cast-aluminum casing. Housing 12 can include a mounted printed circuit board that connects to the various elements described herein below (e.g. switches, display, and USB port). Housing 12 is generally designed to be set on the floor so the musician can read a display 16 from a standing position and can actuate control mechanisms 22 (e.g. switches 22) with the musician's feet.

A visual assembly 14 is provided with the housing 12. The visual assembly 14 may be positioned on or within the housing 12 at a position that is at or near the center of a top surface 12A of the housing 12. Visual assembly 14 includes the display 16 for visually representing performance information in an in-use operation of visual remote control assembly 10. More specifically, the display 16, which may also be referred to as a visual element 16 or a display screen 16, shows data 18 being sent from the CPU of the host computer 102. The display 16 may be any suitable display such as a liquid-crystal display (LCD) or an organic light-emitting diode (OLED) display.

The size or area of display 16 may be described relative to the size or area of top surface 12A. In one or more embodiments, the size or area of display 16 is from about 5% to about 80%, in other embodiments, from about 5% to about 40%, in other embodiments, from about 5% to about 20%, in other embodiments, from about 10% to about 40%, in other embodiments, from about 10% to about 20%, and in other embodiments, from about 20% to about 40%, of the size or area of top surface 12A.

The displayed data 18 can include any desired combination of information regarding the show (e.g. music show or theatre show) for assistance with performance of the show. As shown in FIGS. 1 and 2, this can include a setlist of songs including a selected or current song 18A and an unselected song 18B. The unselected song 18B may be one or more of a previous song or a future song. The setlist of songs information may be displayed at or near the center of display 16.

Data 18 may also include non-song information, such as a status 18C and light information 18D. The status 18C may include an indication of either “Play” or “Stop” to give an indication to the user as to whether the selected song 18A is currently playing. The status 18C may be positioned at or near the top of display 16. The light indication 18D can give an indication to the user as to the status of a certain light or other performance element. The light indication 18D may be positioned at or near the bottom of display 16. Other examples of data 18 include backing tracks, show cues, and MIDI clock data.

A border 20, which may be a raised border 20, may be positioned around the display 16. The border 20 may be utilized for sufficient securement of display 16 within housing 12.

Also positioned on and optionally through top surface 12A of housing 12 is one or more control mechanisms 22. The control mechanisms 22, which are in suitable communication with the firmware of visual remote control assembly 10, allow the user to provide specific instructions to the CPU of the host computer 102. This may also be described as the control mechanisms 22 interacting with or being integrated with the firmware of visual remote control assembly 10. The control mechanisms 22 may be any suitable device, such as switches (e.g. tactile switches), potentiometers, or buttons. The control mechanisms 22 are actuated, which may be referred to as being pressed or activated, in order to send the corresponding instruction to the host computer 102.

The control mechanisms 22 and the associated firmware may include any variety of corresponding instructions for the CPU of the host computer 102. As shown in FIGS. 1 and 2, visual remote control assembly 10 includes a play control mechanism 22A, a stop control mechanism 22B, a next song control mechanism 22C, and a previous song (“prey”) control mechanism 22D. The firmware corresponding with control mechanisms 22 can be designed by the skilled person. The firmware facilitates bilateral communication with the CPU host 102 via companion software on the CPU of the host computer 102. This allows the visual remote control assembly 10 hardware to transmit MIDI note information. The firmware in conjunction with the overall system uniquely allows MIDI ‘system exclusive’ data coming from the companion software to be practically instantaneously encoded (i.e. by the companion software) and transmitted (e.g. by the USB MIDI connection) and decoded (i.e. by the firmware of the visual remote control assembly 10 hardware).

The play control mechanism 22A is configured to play or launch the selected song 18A. The play control mechanism 22A may be positioned to the left of the display 16. The stop control mechanism 22B is configured to stop the selected song 18A. The stop control mechanism 22B may be positioned to the right of the display 16. The next song control mechanism 22C is configured to choose the next song in a playlist. The next song control mechanism 22C may be positioned to the right of the stop control mechanism 22B. The previous song control mechanism 22D is configured to choose the previous song in a playlist. The previous song control mechanism 22D may be positioned to the left of the play control mechanism 22A. Other examples of functions for control mechanisms 22 include a selection mechanism and an arrangement mechanism.

In one or more embodiments, visual remote control assembly 10 consists essentially of housing 12, visual assembly 14, and control mechanisms 22. In one or more embodiments, visual remote control assembly 10 consists of housing 12, visual assembly 14, and control mechanisms 22. In one or more embodiments, control mechanisms 22 consist of play control mechanism 22A, stop control mechanism 22B, next song control mechanism 22C, and previous song control mechanism 22D.

As suggested above, one or more embodiments include a visual remote control system including the visual remote control assembly 10. With reference to FIG. 3, a visual remote control system according to one or more embodiments of the present invention is generally represented with the numeral 100. Visual remote control system 100 includes visual remote control assembly 10 and show computer 102. Show computer 102 may be a desktop computer, a laptop computer, or other suitable computer assembly.

Within visual remote control system 100, visual remote control assembly 10 and show computer 102 are in communication as generally represented with the numeral 104. This communication 104 can utilize the standard Musical Instrument Digital Interface (MIDI) protocol of communication. This communication 104, which may also be referred to as wired connection 104, can be across a USB cable or other suitable communication method. Relative to the wired connection 104, visual remote control assembly 10 may include a communication port 24 within a side surface 12B of housing 12. The communication port 24 may receive a wire or cable (e.g. USB cable) that is also connected with the show computer 102. The wire or cable (e.g. USB cable) should allow for bilateral communication between visual remote control assembly 10 and computer 102.

While aspects of the design of show computer 102 will be generally known to the skilled person, certain details relative to show computer 102 and visual remote control system 100 are now described. A suitable software product on show computer 102 is developed for organizing the song setlist and other show details on the show computer 102. The suitable software enables interaction with the song setlist and other show details via the visual remote control assembly 10.

The suitable software dynamically retrieves data from a musical application (e.g. Ableton Live) hosted on show computer 102 and sends part of this data (e.g. playlist data) to the visual remote control assembly 10 hardware. This sending of data enables the onstage user to see the data as displayed on the visual remote control assembly 10. For example, the visual remote control assembly 10 can display the current song, the previous song, and the next song. More specifically regarding the data, the to-be-sent data is encoded as MIDI system exclusive data and is transmitted from show computer 102 to visual remote control assembly 10 (e.g. across a USB cable). The sent data will then be decoded at the visual remote control assembly 10 from the MIDI system exclusive data to a readable ASCII format so the sent data can be displayed on the display 16 of visual remote control assembly 10. The firmware of the visual remote control assembly 10 is then suitable for sending corresponding instructions from the visual remote control assembly 10 back to show computer 102.

In one or more embodiments, visual remote control system 100 consists essentially of visual remote control assembly 10, show computer 102, and communication 104. In one or more embodiments, visual remote control system 100 consists of visual remote control assembly 10, show computer 102, and communication 104. Visual remote control system 100 may be in indirect communication with one or more musical instruments, for example, by way of a playback rig.

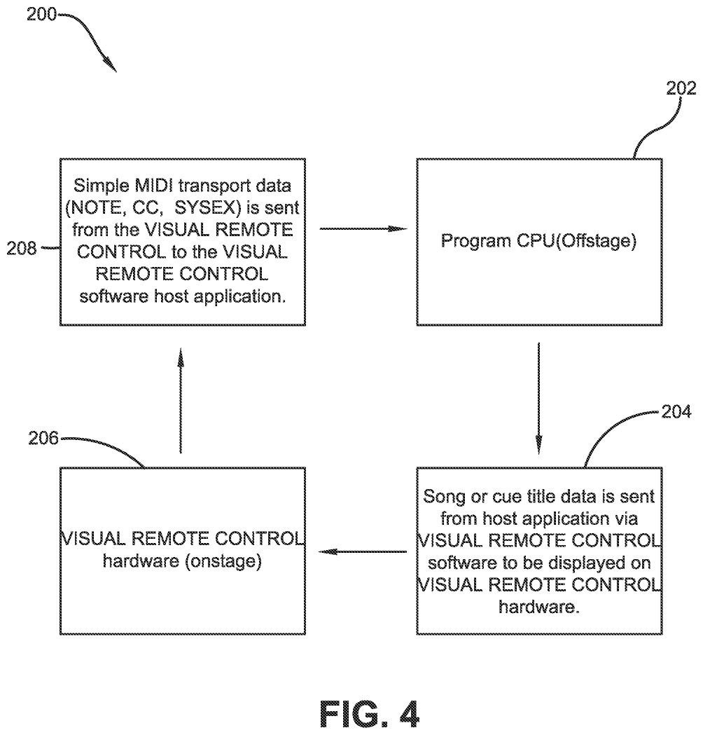

As suggested above, one or more embodiments include a method of operating visual remote control system 100. While aspects of the method are disclosed above, further reference will be made to FIG. 4. With reference to FIG. 4, a method of operating visual remote control system according to one or more embodiments of the present invention is generally represented with the numeral 200.

In a first step 202, the visual remote control system 100 is provided, which includes suitable design thereof in accord with the above discussion. As mentioned above, this generally includes providing the suitable software product on show computer 102 as well as adding and organizing the song setlist and the other show details on the show computer 102. In certain preferred embodiments, show computer 102 may be offstage relative to the musician and visual remote control assembly 10. Though in other embodiments, show computer 102 may be onstage (either out of view or in view) with the user and visual remote control assembly 10.

In step 204, at least a portion of the data from step 202 is dynamically retrieved by the suitable software from a musical application (e.g. Ableton Live) on the show computer 102. This retrieved data is then sent by the show computer 102 to the visual remote control assembly 10 hardware for display thereon. Step 204 generally includes a user instructing the show computer 102 to send the data to the visual remote control assembly 10.

In step 206, the retrieved data is displayed on visual remote control assembly 10 such that the user can view and utilize the retrieved data for the show. The user can then interact with visual remote control assembly 10 while the retrieved data is displayed.

In step 208, the user can send corresponding instructions from the visual remote control assembly 10 back to show computer 102. This can include the user interacting with control mechanisms 22. The show computer 102 will receive this input and will provide an output back to visual remote control assembly 10, thereby repeating the steps of method 200. Since the user has now sent instructions to the show computer 102, the output from the show computer 102 following the repeating of the method steps will generally include at least partially different data than the data sent during step 204.

As should be appreciated from the above disclosure, embodiments of the present invention provide significant advantages. One or more embodiments described herein may also have one or more of the following advantages:
a) providing the ability to discretely select, confirm, and launch the appropriate cue or song;
b) eliminating the need to visually confirm songs or cues by looking at a monitor of the program computer;
c) eliminating the need to bring the program computer to the performing stage;
d) eliminating the need for the performer to rely on another person to operate the program computer from side stage or backstage;
e) eliminating the requirement for the performer needing to manipulate a setlist of songs without actually seeing what is being controlled; and
f) eliminating the need to utilize a modified item (e.g. drum pads) as a small MIDI controller.

In light of the foregoing, it should be appreciated that the present invention significantly advances the art by providing an improved visual remote control assembly and corresponding system and method. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A visual remote control assembly comprising
a housing hosting firmware suitable for allowing communication between the visual remote control assembly and a show computer;
a display screen capable of receiving the communication from the show computer, the communication including data regarding a show performance, the display screen displaying the data regarding the show performance in an in-use operation of the visual remote control assembly, wherein the data regarding the show performance includes a song setlist including a current song, a next song, and a previous song; and
a plurality of control mechanisms interacting with the firmware to thereby allow instructions to be sent to the show computer upon a user actuating the plurality of control mechanisms.

2. The visual remote control assembly of claim 1, the housing having a top surface with a center, the visual assembly being positioned at or near the center of the top surface of the housing.

3. The visual remote control assembly of claim 2, wherein the display screen has a size that is from about 5% to about 40% of an overall area of the top surface.

4. The visual remote control assembly of claim 1, wherein the display screen is a liquid-crystal display (LCD) or an organic light-emitting diode (OLED) display.

5. The visual remote control assembly of claim 1, wherein the plurality of control mechanisms includes a play control mechanism, a stop control mechanism, a next song control mechanism, and a previous song control mechanism.

6. The visual remote control assembly of claim 5, wherein the plurality of control mechanisms consists of the play control mechanism, the stop control mechanism, the next song control mechanism, and the previous song control mechanism.

7. The visual remote control assembly of claim 1, wherein the housing is a small form factor hardware device.

8. The visual remote control assembly of claim 1, wherein the display screen is part of a visual assembly, the visual assembly further comprising a border surrounding the display screen, the border securing the display screen within the housing.

9. The visual remote control assembly of claim 1, wherein the song setlist is positioned at or near a center of the display screen, the data regarding the show performance further comprising a play or stop status, the play or stop status being positioned at or near a top of the display screen.

10. The visual remote control assembly of claim 9, the data regarding the show performance further comprising a light status, the light status being positioned at or near a bottom of the display screen.

11. The visual remote control assembly of claim 1, wherein the communication between the visual remote control assembly and the show computer is Musical Instrument Digital Interface (MIDI) protocol of communication.

12. The visual remote control assembly of claim 1, the housing further comprising a side surface having a communication port receiving a wire or cable connected with the show computer.

13. A visual remote control system comprising
a show computer having data regarding a show performance;
a visual remote control assembly; and
a wire or cable connecting the visual remote control assembly with the show computer;
the visual remote control assembly including
a housing hosting firmware suitable for allowing communication between the visual remote control assembly and the show computer across the wire or cable;
a display screen receiving the communication from the show computer across the wire or cable, the communication including the data regarding the show performance, the display screen displaying the data regarding the show performance in an in-use operation of the visual remote control assembly, wherein the data regarding the show performance includes a song setlist including a current song, a next song, and a previous song; and
a plurality of control mechanisms interacting with the firmware to thereby allow instructions to be sent to the show computer upon a user actuating the plurality of control mechanisms.

14. The visual remote control assembly of claim 13, wherein the communication between the visual remote control assembly and the show computer is Musical Instrument Digital Interface (MIDI) protocol of communication.

15. The visual remote control assembly of claim 14, wherein the communication from the show computer is encoded as MIDI system exclusive data, wherein the visual remote control assembly decodes the MIDI system exclusive data to decoded data of a readable ASCII format for display of the decoded data on the display screen.

16. The visual remote control assembly of claim 13, the housing further comprising a side surface having a communication port receiving the wire or cable.

17. The visual remote control assembly of claim 13, wherein the visual remote control assembly is onstage with a user, and wherein the show computer is offstage.

18. A method of operating a visual remote control system, the method comprising steps of
providing the visual remote control system including a visual remote control assembly, a show computer, and a wire or cable connecting the visual remote control assembly with the show computer;
instructing the show computer to send initial data regarding a show performance to the visual remote control assembly;
viewing the initial data regarding the show performance on a display screen of the visual remote control assembly; and
instructing, via a control mechanism of the visual remote control assembly, the show computer to send additional data regarding a show performance to the visual remote control assembly, where the additional data is different from the initial data.

19. The method of claim 18, wherein the step of instructing via the control mechanism of the visual remote control assembly includes pressing a button of the control mechanism.

20. The method of claim 18, wherein the step of instructing via the control mechanism of the visual remote control assembly includes selecting a next song.
